(19) United States
(12) Patent Application Publication
(10) Pub. No.: US 2014/0280989 A1
(43) Pub. Date: Sep. 18, 2014

(54) SYSTEM AND METHOD FOR ESTABLISHING PEER TO PEER CONNECTIONS THROUGH SYMMETRIC NATS

(71) Applicants: Thomas J. Borkowski, Samammish, WA (US); Stephen Anthony Larson, Oroville, WA (US); Daniel D. Smith, Tonasket, WA (US)

(72) Inventors: Thomas J. Borkowski, Samammish, WA (US); Stephen Anthony Larson, Oroville, WA (US); Daniel D. Smith, Tonasket, WA (US)

(21) Appl. No.: 13/829,050

(22) Filed: Mar. 14, 2013

(51) Int. Cl. H04L 29/08

(52) U.S. Cl. CPC H04L 29/08576
USPC 709/228

(57) ABSTRACT

A system and method for establishing a direct peer to peer communication link between computers connected to the Internet through symnat routers. One client computer (Client B) is instructed by a server to open a number of targets by sending packets to a range of port numbers beginning with another computer's (Client A) last known public port number. Client A is then instructed by the server to send a number of packets at the last known port used by client B but each time increasing its (Client A's) port number. If a packet is sent where the To and From ports of both client computers match, a peer to peer communication link can be established.

### TECHNICAL FIELD

The disclosed technology relates to computer systems in general and in particular to systems for establishing direct communications between computers.

### BACKGROUND

There are many instances where users of computer systems would like to be able to communicate with each other without having to involve an intermediate server computer to relay packets between the computer systems. This is particularly true in video conferencing and other real time applications where the use of an intermediate server slows the communication time.

Most computers are connected to the Internet though a network address translator router (NAT) that operates to change the outward appearing IP address and port of a computer that are visible to other computers on the Internet. The NAT therefore provides some level of security for the computer behind the NAT because packets are only delivered to the computer if the IP address and port numbers of both computers match.

There are several different types of NATs. These include Full Cone NATs, Restricted Cone Nats, Port Restricted <Cone> NATs and Symmetric NATs (symnats). When computers are located behind Full Cone, Restricted or Port Restricted NATs, it is fairly easy for an intermediate sever computer to establish communication between two computers that want to communicate with each other. However, if both computers are behind Symmetric NATs, it is much more difficult or near impossible for a server to set up the communication links. This is particularly true when either computer may send out seemingly random packets that change their public port numbers or the port numbers change due to unrelated traffic from the same or a different computer behind the symnat. Therefore, there is a need for a system that can reliably establish connections between computers behind symnats that want to communicate with each other.

### BRIEF DESCRIPTION OF THE DRAWINGS

FIG. 1 shows a system for establishing communications between computer systems that are located behind symmetric NATs in accordance with an embodiment of the disclosed technology;

FIG. 2 is a flow chart of steps performed by a server computer and two client computers to establish communication in accordance with an embodiment of the disclosed technology; and

FIG. 3 is a timing diagram showing the flow of messages sent between two computers and a server in order to establish a direct communication link between the two computers in accordance with an embodiment of the disclosed technology.

### DETAILED DESCRIPTION

As discussed above, there is a need for a system that can reliably establish a communication connection between computers that are located behind symmetric NATS (symnats). In one embodiment shown in FIG. 1, a server computer 100 includes one or more processors that are configured to execute a sequence of program instruction that set up a peer to peer communication connection between a number N of client computers 101, 102, 103 etc. In one embodiment, the server computer sets up the peer to peer communication connections that can be used for video conferencing or computer sharing (e.g. live meeting) type applications. The particular use for the peer to peer communication link is controlled by the connected computers.

Each computer is connected to a public network such as the Internet through a network address translator (NAT). For example, client computer 101 is connected to the Internet through a NAT 111. Client computer 102 is connected to the Internet through NAT 112. If the client computer 101 wants to set up a peer-to-peer communication link with the computer 102 (or any other computer), the public IP address and port of the client computer 102 must be known by its NAT and by client computer 101. As indicated above, this is generally difficult if the NATs 111 and 112 are symnats because the client computers 101 and 102 must have sent messages to each another in the last several seconds and because the port numbers used by the NATs can change in a seemingly random fashion. Therefore it is difficult for the server computer to tell each of the clients that wish to set up the peer to peer communication link what IP address and port to use to communicate with the other.

To overcome the above difficulties, the server computer 100 is programmed to execute a program that operates to establish peer to peer communication links between authenticated users who have valid accounts to use the server and connect to other users. In one embodiment, the server computer performs different functions including authenticating client computers and managing customer accounts as well as setting up the peer to peer communication links between authenticated users. An additional server (not shown) is associated with the sever 100 and is used to receive “garbage” IP packets that are used to initialize a socket as will be described below.

During a registration process, the server saves the Private IP Address, Private Port information of each registered client computer as well as the Public IP Address and Public Port information of each computer. In addition, during registration of a client computer, the server computer 100 notes what type of NAT the client is using. In one embodiment, the server computer determines the type of NAT using the STUN algorithm (RFC 3489) or using the Classic STUN algorithm (RFC 5389). The type of NAT is saved for each registered user to facilitate establishing peer to peer connections. In one embodiment, only these five pieces of information are stored for each registered user so that the server 100 can operate as a stateless machine. The server computer 100 can also store such information as billing information and login (e.g. user name/password) information etc. to charge users for establishing the communication links and prevent unauthorized use of the service.

To establish a peer to peer connection between two clients—referred to as client A and client B below, the server computer 100 instructs one of the computers to open a number of target IP and port combinations. The server then instructs the other client computer to attempt to communicate with each of the opened IP and port combinations. In the example described below, one computer can be thought of as a target (e.g. client B) and the other computer can be thought of as an archer (client A) shooting arrows at the target. If any of the arrows (e.g. an IP address and port combination) matches an IP and port combination that is open on the target, then the computers can communicate directly without having to use the server 100 as an intermediary.

In one embodiment, each of the client computers executes an application program that enables it to establish a peer to peer communication connection with another client and to communicate with the server 100. Upon executing the application, each of the client computers opens two or more sockets and initializes them by sending a packet to the garbage IP address. In one embodiment, it was found that the port number used by a symnat can jump unpredictably the first time a socket is used. Therefore initializing the sockets makes the port numbers vary in a predictable manner after initialization. In addition, each client opens a communication link with the server 100. Heartbeat packets are periodically sent from the client computers to the server to keep the ports used for communication open in the event of a period of inactivity.

In one embodiment, the server computer and the client computers execute the steps as shown in FIGS. 2 and 3 to establish a peer to peer communication link through their respective symnats. Although the steps are shown and described in a particular order for ease of explanation, it will be appreciated that the steps may be performed in a different order or different steps performed while still achieving the functionality described.
Step 0—A client computer (Client A) makes a request to the server 100 to establish a peer to peer communication connection with a specific client computer (Client B).
Step 1—In one embodiment, the server 100 instructs the Client B computer to do a NATTEST to determine its current Port.
Step 2—Client B computer sends the NATTEST results to the server 100, which gives the server the current Port number of Client B's SYMNAT, which is forwarded to the Client A computer in Step 3. Steps 1 and 2 are optional and may be omitted if desired.
Step 3—The server 100 instructs Client A computer to do a NATTEST from which the sever 100 can determine Client A's current port.
Step 4—Client A sends the NATTEST results to the server 100, which gives the server Client A's current SYMNAT port number. This step is important to the success of the SYMNAT to SYMNAT connection process and if the Client A port number is wrong for any reason the process will fail. This port is forwarded to Client B in Step 5.
Step 5—The server 100 instructs the Client B computer to use Client A's current port (Port) number to create “Targets” in Step 6 which the Client A computer will use in Step 9.
Step 6—The Client B computer is instructed by the server to send 10 (or a greater or fewer number) data packets to the next 10 ports (i.e. Port+1, Port+2, . . . , Port+10) at Client A's known Public IP Address: This is defined as a Multiple Punch Through Protocol (MPTP) and effectively opens 10 holes (or targets) in Client B's SYMNAT router that Client A can use to send data packets to Client B in Step 8.
Step 7—The Client B computer is instructed to send a “Done” packet back to the server 100. This step is very important to the success of the SYMNAT to SYMNAT connection process and if the Client B port number is wrong for any reason the process will fail. In one embodiment, Client B sends the “Done” message back to the server 100 though a different initialized socket than the one it was previously using to communicate with the server 100. Sending a packet to a new IP address through the new socket (previously used to send a packet to the garbage IP address) causes the symnat to increase the current port number of Client B by 1. From this “Done” packet, the server is then able to determine the last port opened by Client B. This port is forwarded to Client A in Step 8.
Step 8—The server 100 then instructs the Client A computer to use Client B's current port (Port) number to send a number of data packets to the Client B computer (Shoot at the Targets that the Client B computer created in Step 6).
Step 9—The Client A computer is programmed to subtract some number, such as two (2), from Client B's current port (Port) and to send 10 packets to the Client B computer starting with the current port of Computer B less the number (e.g. the current Port minus two), which effectively opens the next 10 ports in Client A's SYMNAT which were the ones that Client B<attempted to send> sent the data to in Step 6.
If there is traffic through client A's symnat router during the time between when Client A sends step 4 (NATTEST) to the server 100 and when Client A 101 sends the packets to client B 102 in step 9, the 10 ports that client B used in step 6 may be taken, or more specifically would be taken if there happened to be more than 10 new communication attempts through Client B's NAT. If these ports have not been used by traffic, there is an excellent chance to make the connection. Note that as used in FIG. 3, Port₃ is used as shorthand to refer to the last port used by Client B.
Step 10—The Client A computer sends a “Done” packet back to the server.
Step 11—The Client B computer is programmed to respond to the Client A computer if data was received at Step 9.
Step 12—Client B sends an “Acknowledge” to the Client A computer.
Step 13—The Client B computer sends a “Done” signal back to the server.
Step 14—The server instructs the Client A computer to Re-Acknowledge the packet from the Client B computer in Step 12.
Step 15—The Client A computer sends a Re-Acknowledge to the Client B computer.
Step 16—The Client A computer sends a “Done” signal back to the server.
Step 17—The Server 100 logs the connection as complete (On a Server Monitor—no data is saved about this connection at the Server)
Step 18—In one embodiment, if the connection is aborted (or fails) a Retry is used to try and establish the connection for a total of 3 times (or make 3 attempts) before total connection failure is realized.

In another embodiment, the server computer and the client computers execute steps to establish a peer to peer communication link through their respective symnats. Although the steps are shown and described in an particular order for ease of explanation, it will be appreciated that the steps may be performed in a different order or different steps performed while still achieving the functionality described. In the embodiment described below, it doesn't matter which client A or B starts sending packets to establish the connection.
Step 0—A client computer (Client A) makes a request to the server 100 to establish a peer to peer communication connection with a specific client computer (Client B).
Step 1—In one embodiment, the server 100 instructs the Client A computer and Client B computer to do a NATTEST to determine their current Ports.
Step 2—Client A computer sends the NATTEST results to the server 100, which gives the server the current Port number of Client A's SYMNAT which is forwarded to the Client B in Step 6.
Step 3—Client B computer sends the NATTEST results to the server 100, which gives the server the current Port number of Client B's SYMNAT which is forwarded to the Client A in Step 4.
Step 4—The server 100 instructs the Client A computer to add some number, such as eight (8), to Client B's current port (Port), obtained in Step 3, and to send 10 packets to the Client B computer at that port incrementing Client A's From port starting with the current port of Computer A, obtained in Step 2, which effectively opens the next 10 ports in Client A's SYMNAT which are the ones that Client B sends the data in Step 7.
Step 5—The Client A computer is programmed to send a “Done” packet back to the server after completing Step 4.
Step 6—The server 100 instructs the Client B computer to send 10 data packets to the next 10 ports (i.e. Port+1, Port+2, . . . , Port+10), obtained in Step 2, to Client A's known Public IP Address from port starting with the current port of Client B computer and each time increasing its From port number, obtained in Step 3, which effectively opens the next 10 ports in Client B's SYMNAT which includes one at which that Client A sends the data to in Step 4.
Step 7—The Client B computer is programmed to send a “Done” packet back to the server after completing Step 6.
Step 8—The Client A computer is programmed to respond to the Client B computer to complete connection if data was received from the Client B computer.
Step 9—The Client B computer is programmed to respond to the Client A computer to complete connection if data was received from the Client A computer.
Step 10—Upon receiving a Done from the Client B computer, the server 100 instructs the Client A computer to add some number, such as eight (8), to Client B's current port, obtained in Step 3 and send the same 10 packets to the Client B computer as sent in Step 6.
Step 11—The Client A computer is programmed to send a “Done” packet back to the server after completing Step 10 unless the Client computers have connected as a result of Step 8 or Step 9.
Step 12—Upon receiving a Done from the Client A, the server 100 instructs the Client B computer to send the same 10 data packets to Client A computer at the 10 ports (i.e. Port+1, Port+2, . . . , Port+10), obtained in Step 2, at Client A's known Public IP Address, which are the same 10 packets as sent in Step 4.
Step 13—The Client B computer is programmed to send a “Done” packet back to the server after completing Step 12 unless the Client computers have connected as a result of Step 8 or Step 9.
Step 14—In one embodiment, if the connection is aborted (or fails) Client A initiates a Retry by beginning with Step 1.

The server in the disclosed implementation is designed to be stateless in which it only stores vitally important data for the peer-to-peer connection process. The server does not do any predicting of port numbers in this implementation.

The disclosed technology is not limited to establishing communications between two computers. Multiple clients can be connected in a fully-connected peer to peer grid using the steps described above.

The following are examples of how Client A can establish a peer to peer connection with Client B where there is no traffic and when there is traffic. The traffic may come from another program operating on the client computers.

Example with No Traffic.

In this example, Client B is instructed to open a number of targets beginning with Client A's current port (125). As can be seen in the table below, each time Client B sends a packet to a new TO port, its symnat increases Client B's current FROM port by 1.
After the server is informed that Client B has opened the 10 (or fewer or greater) targets, the server instructs Client A to send a number of packets to client B's last known port (57 as determined from Client B's “Done” message to the server). Each “arrow” fired by Client A increases its FROM port number by 1.

| Client B | Client A |
|---|---|
| TO: 125 | TO: 57 |
| From: 50 | From: 125 |
| TO: 126 | TO: 57 |
| From: 51 | From: 126 |
| TO: 127 | TO: 57 |
| From: 52 | From: 127 |
| TO: 128 | TO: 57 |
| From: 53 | From: 128 |
| TO: 129 | TO: 57 |
| From: 54 | From: 129 |
| TO: 130 | TO: 57 |
| From: 55 | From: 130 |
| TO: 131 | TO: 57 |
| From: 56 | From: 131 |
| TO: 132 | TO: 57 |
| From: 57 | From: 132 |
| TO: 133 | TO: 57 |
| From: 58 | From: 133 |
| TO: 134 | TO: 57 |
| From: 59 | From: 134 |

In this example, Client B's packet sent TO: 57 From: 132 should get through to Client A, and A's packet send TO: 132 From: 57 may also get through depending on the transmission order and number of times they are resent.
If there was traffic going through the symnat router, the From: port #'s will be higher, not in sequence, and may have ports not in the block.

Example with Traffic

In this example, Client B opens 10 targets starting with Client A's last known port number (125). However, there is intervening traffic so the port number assigned by Client B's symnat is not sequential (see the jumps after ports 57, 60, 65).
After the 10 targets have been opened, Client A sends 10 packets to the last known port of Client B (less some number) and each time increases its own port number.

| Client B | Client A |
|---|---|
| TO: 125 | TO: 57 |
| From: 56 | From: 126 |
| TO: 126 | TO: 57 |
| From: 57 | From: 128 |
| TO: 127 | TO: 57 |
| From: 59 | From: 129 |
| TO: 128 | TO: 57 |
| From: 60 | From: 131 |
| TO: 129 | TO: 57 |
| From: 62 | From: 132 |
| TO: 130 | TO: 57 |
| From: 63 | From: 22 |
| TO: 131 | TO: 57 |
| From: 64 | From: 134 |
| TO: 132 | TO: 57 |
| From: 65 | From: 135 |
| TO: 132 | TO: 57 |
| From: 68 | From: 138 |
| TO: 132 | TO: 57 |
| From: 69 | From: 139 |

In this example, Client B's packet TO: 57 From: 126 should get through to Client A, and Client A's packet TO: 126 From: 57 may also get through.

As will be appreciated by those skilled in the art, the disclosed technology is implemented by requesting that the first and second client computers perform acts under the direction of the server computer. The acts to be performed are encoded as computer instructions that are executed by processors in the client computers. The instructions may be stored on the client computers and executed upon request by the server. Alternatively, the server may use a communication connection to provide the instructions to the client computers each time a peer to peer connection is to be established. That is, the software executed by the client computers may be stored on the client computers or received from the server computer.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus.

A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium also can be, or can be included in, one or more separate physical components or media (e.g., multiple CDs, disks, or other storage devices). The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus also can include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., an LCD (liquid crystal display), LED (light emitting diode), or OLED (organic light emitting diode) monitor, for displaying information to the user and a keyboard and a pointing device, e.g., a mouse or a trackball, by which the user can provide input to the computer. In some implementations, a touch screen can be used to display information and to receive input from a user. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include any number of clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

I/We claim:

1. A computer system that is configured to execute instructions in order to establish a peer to peer communication connection between a first client and a second client computer that access a public communication network through symmetric network address translators (NATs), comprising;
a memory for storing a sequence of program instructions;
a processor that is configured to execute the instructions in order to:
receive a request from a first client computer to establish a connection with a second client computer;
instruct the first client computer to send a message indicating its current port;
provide the current port of the first client computer to the second client computer;
instruct the second client computer to send a number of packets to a range of TO port numbers beginning with the current port of the first client computer, wherein packet sent by the second client computer uses a different FROM port number;
receive a message from the second client computer that indicates the current port of the second client computer; and
instruct the first client computer to send a number of packets to a port number that is likely in a range of port numbers used by the second client computer when it sent its packets, wherein each packet sent by the first client computer is sent from a changing FROM port number.

2. The computer system of claim 1, wherein the processor is configured to execute instructions that
instruct the second and first client computers to acknowledge each other if a packet is transmitted and received between the first client computer to the second client computer; and
receive an acknowledgement from the first and second client computers that they have established a communication link.

3. The computer system of claim 1, wherein the computer system is configured to execute instructions that request the current port of the first client computer by requesting that the first client computer perform a NATTEST operation.

4. The computer system of claim 1, wherein the computer system is configured to execute instructions that request that the second client computer send a message reporting its current port number using a different socket.

5. The computer system of claim 1, wherein the computer system is configured to execute instructions that request the first client computer to send packets to the current port of the second client computer less a predetermined value.

6. A non-transitory computer readable media with instructions thereon that are executable by a computer system in order to establish a peer to peer communication connection between a first client and a second client computer that access a public communication network through symmetric network address translators (NATs), the wherein when executed the instructions cause a processor to;
receive a request from a first client computer to establish a connection with a second client computer;
instruct the first client computer to send a message indicating its current port;
provide the current port of the first client computer to the second client computer;
instruct the second client computer to send a number of packets to a range of TO port numbers beginning with the current port of the first client computer, wherein packet sent by the second client computer uses a different FROM port number;
receive a message from the second client computer that indicates the current port of the second client computer after the second client computer has sent the number of packets to the range of TO port numbers; and
instruct the first client computer to send a number of packets to a port number that is likely in a range or port numbers used by the second client computer when it sent its packets, wherein each packet sent by the first client computer is sent from a changing FROM port number.

7. A non-transitory computer readable media with instructions thereon that are to be executed by processors in two client computers to establish a peer to peer communication connection, wherein the instructions cause the processors in the first and second computers to:
receive an indication at the second client computer of a last FROM port used by first client computer;
transmit a number of packets from the second computer that are addressed to the first computer, wherein the packets are sent to a range of TO ports starting at the last port used by the first computer and changing the FROM port for each packet sent; and
transmit a number of packets from the first computer that are addressed to the second computer, wherein the packets are sent to a port included in the range of TO ports used by the second computer and each time changing the FROM port number such that at least one of the TO and FROM ports of packets sent by the first and second computers will match.
